(19) United States
(12) Patent Application Publication
(10) Pub. No.: US 2001/0052873 A1
(43) Pub. Date: Dec. 20, 2001

(54) Global positioning system stamp machine

(76) Inventor: Ahmad (Dulce) Rezai, Malibu, CA (US)

Correspondence Address: AHMAD (DULCE) REZAI, 28 HASKELL DRIVE, BRATENAHL, OH, 44108, US

(21) Appl. No.: 09/879,884

(22) Filed: Jun. 14, 2001

Related U.S. Application Data
(60) Provisional application No. 60/211,372, filed on Jun. 14, 2000.

(51) Int. Cl. G01C 21/26; G01C 21/28; G01C 21/30

(52) U.S. Cl. 342/357.01; 701/207

(57) ABSTRACT

The purpose of the GPS3M is for tracking purposes, either personal or professional, enabling users of GPS3M technology to assign a unique number that can never be duplicated regardless of where or when the stamp is used. A “fingerprint” of matter, if you will—any matter—large or small—animate or inanimate. Reliance of the philosophy behind GPS3M is in the simple fact that no two objects can occupy the same space at the same time. This uniqueness is what GPS3M is all about. GPS3M would be able to provide a simple mode of recording and retrieving information based on coordinates in time and space. GPS3M furthermore offers intuitive advantages that cross cultural barriers, and even technological ones, given that virtually all individuals on the planet by need of a means of communication have an inherent understanding of the nature of time and space. This inherent understanding is common grounds by which computers and software programs would as easily as the humans that made them be able to discern, allowing potential for communication amongst computers, any corresponding software applications, even humans especially in light of an impressive array of new as well as established means in data input, including cell phones with built in tracking signals, Personal Digital Assistants, and increasingly effective alphanumeric voice identification potential. GPS3M simply, with high degree of accuracy/ease/reliability, measures and stamps time and location in a manner understandable by entity of origin via use of alphanumeric symbols or digitization. Since one of the important purposes for GPS3M is communication amongst human and non-living computational applications, GPS3M by convention needs be recorded in both human and machine forms of input.

### BACKGROUND OF THE INVENTION

The entitled invention described herein takes advantage of well-established means and methods in Global Positioning System for the discernment of location as well as time. It also makes use of time stamp machines frequently utilized for decades in the course of employment, for reasons of tracking employee work hours. Furthermore, the invention also employs the use of Universal Product Code (UPC) and similar Bar Code technology for incorporation of information into simple or more complex computation applications, such as a personal hand held computer, currently popularly recognized as Personal Digital Assistants or PDA. The herein listed invention furthermore utilizes more current encoding technology, magnetic stripe technology or Smart Chip technology both utilized for recording and recovery of information.

### BRIEF SUMMARY OF THE INVENTION

Via already well established technology in Global Positioning System, recording of alphanumeric symbols and digital encoding utilized for incorporation, assimilation and subsequent computation of data, the herein described GPS3M makes use of all these well established means and methods in technologies and applications to act as a simple, portable unique encoding system utilized in either a hand-held portable, desktop model or industrial model GPS3M encoding.

The herein invention is able to provide a unique assigned encoding in a very simple, efficient manner, based on enhanced Global Positioning System and Relative Positioning Systems information acquisition from either U.S. or emerging European Global Positioning Systems as well as confirmation and subsequent terrestrial triangulation by fixed position enhancement used for both calibrations and verification as well as greater accuracy, that permit a unique assignment of a code based on the premise that any given matter can only occupy only one particular space at any given particular time. Hence, a unique assigned code that holds the advantage of being able to be read by those holding simple alphanumeric skills as well as customer option for means in recording via older or newer forms in digitalization and transfer of data whether through Bar Encoding technology and subsequent use of scanners for input into computers or digitalization via Magnetic Strip encoding technology or Smart Chip encoding technology or other currently emerging methods that offer more efficient, effective means in input of simple Space×Time data into a simple or more sophisticated computer for tracking and identification purposes.

It is indeed a truism that no such device exists to date that offers the consumer, the business owner unique encoding that cannot ever be replicated. The inherent power of this technology and the herein described immediate application is in the fact that both time and space have by and large been quite standardized, well understood, expressed, deciphered to both an inherent and intuitive level. GPS3M is essentially a portable stamp, much like a Rubber Stamp that is able to assign a unique code, a unique (Longitude×Latitude)×(Time). This encoding may subsequently be used in cross functional platform applications, for humans as well as machines to communicate in a hyper efficient manner, as if though speaking the same language.

One example that immediately comes to mind is tracking of parcel. Each government or privately held shipping entity has its own set of computer programs that are by and large unique to its own. With the imprinting of unique codes, specific locations at specific times can be utilized to ascertain exact location, such as Fed Ex station in Arlington, Va. located at the longitude×latitude that corresponds not only to a given branch, but a given office, given Fed Ex employee who was occupying a particular space (e.g. his assigned station) at a particular time. Therefore, any subsequent need to track variables such as who, where, when, and what would be readily be available through correlation input and analysis. An independent shipping agency in central Mongolia via use of very different technology, if any at all would be able to far more efficiently discern location for when and where the GPS3M was employed. Those exact numbers would in turn have specific implications. It is essentially an intuitive means by which data may be communicated readily via different computers or species. No hand-held, desktop or industrial design of the kind exists to date.

In summary, the purpose of the entitled GPS3M is for efficient logging that takes advantage of a unique code that can never be replicated, ever, and hence is of value in ease of use by different companies and individuals in a manner that is standard, intuitive and self explanatory. Specifically, the invention takes advantage of the fact that no mass can occupy the same space at the same time. Hence by classification of the geography and time, a Log is kept in human readable alphanumeric characters as well as a standard encoding quickly retrievable by computers.

### BRIEF DESCRIPTION OF THE DRAWINGS

Not Applicable

### DETAILED DESCRIPTION OF THE INVENTION

Given that various materials and methods have long been established for the production of the individual parts of this herein GPS3M invention, that the individualized components utilized in the GPS3M have been on the market for extensive periods of time, and that the proposed GPS3M is unique in its combination of components, with extensively established means and methods for production of individual components that go into the designated GPS3M, claims are made for a combination of well established modes in determination of time and space. Given that indeed, no product exists to date, for the unique combination of valuable features in the herein described GPS3M, a detailed description of means and methods for the production of already well established items consumers today frequently use would be deemed unnecessary in that the individual components have not been invented, but utilized, combined in a unique, and more importantly, simple manner, so as to yield a unique code based on established means in location and the corresponding verification. Claims are hereby being made for a stamp machine whose value is significant and whose presence in the market is absent, and whose components are common, well established and hereby combined in a unique manner.

All things have an inherent fingerprint by mere virtue of being matter, therefore all matter has fingerprints. The purpose thus is to help translate these inherent fingerprints to a form understandable by all computing entities, human, machine or computer. Regardless of location on earth, regardless of taught language, there are fundamentals in time, distance (space, geography, longitude, latitude). Neither time nor space is subject to translation—it is a language understood that may be represented only in terms of numbers, and more importantly in a simple, intuitive manner. So simple is this that not only humans from differing cultures may readily communicate, but utilize fingerprint banks that are able to decipher unique, given times×space which can never be duplicated. Only one item, one matter, one thing may occupy a given space at a given time. GPS3M banks on this inherent uniqueness. The importance of the proposed GPS3M is in recording capability of specific coordinates at specific times, by mere numbers that humans can read, as can computers. It is a standardized communication mode between humans and machines at the most unique and fundamental level.

1. Assignment of a unique, unreplicatable “fingerprint”, based on refinement of Global Positioning System signal to centimeter or sub-centimeter accuracy in the event that a GPS signal may not be as accurate as desired.

2. Provide the parties of interest with a means by which they are able to assign a unique, unreplicatable code, in a simple, effective, efficient manner. Available in ink stamp form documentation via alphanumeric symbols or computer-scanable code bars or digitalization for use by computers and corresponding applications.

3. GPS3M encoding “fingerprint” to be used for locating, tracking items of interest in a highly specific manner.

4. GPS3M encoding may be used for cross functional platforms, as a common language practiced by both humans as well as computers (i.e. a common language)
